(19) United States
(12) Patent Application Publication
(10) Pub. No.: US 2026/0015077 A1
(43) Pub. Date: Jan. 15, 2026

(54) METHODS, SYSTEMS, AND DEVICES FOR A DOOR FOR A VEHICLE

(71) Applicant: SUPERNAL, LLC, Washington, DC (US)

(72) Inventors: Alexander POZZI, Washington, DC (US); Benjamin David STEPHENS, Washington, DC (US); Mark BJORNHOLM, Washington, DC (US); Mauricio CASTRO, Washington, DC (US)

(21) Appl. No.: 18/993,838

(22) PCT Filed: Jul. 12, 2023
(86) PCT No.: PCT/US2023/027564

§ 371 Date: Jan. 13, 2025

Related U.S. Application Data
(60) Provisional application No. 63/368,327, filed on Jul. 13, 2022.

(51) Int. Cl. B64C 1/14; B64C 1/24; E05F 15/53

(52) U.S. Cl. CPC B64C 1/1407; B64C 1/24; E05F 15/53; E05Y 2900/502; E05Y 2900/531

(57) ABSTRACT

A vehicle (600, 700) is disclosed. The vehicle (600, 700) includes a body forming a door opening. The vehicle (600, 700) also includes a first hinge (607, 707) coupled to the body. The vehicle (600, 700) further includes a door (608, 708) coupled to the body at the door opening and movable between an open position and a closed position. The door (608, 708) includes a first door portion (608A, 708A) including a first end and a second end opposite the first end. The first end is coupled to the first hinge (607, 707) and configured to rotate in a first direction in the open position and the second end is coupled to a second hinge (609, 709). The door (608, 708) also includes a second door portion (608B, 708B) coupled to the second hinge (609, 709) and configured to rotate at an angle to the first door portion (608A, 708A) in the open position and form a single surface with the first door portion (608A, 708A) in the closed position.

### CROSS-REFERENCE TO RELATED APPLICATION

The present application claims priority to provisional U.S. Application No. 63/368,327 filed Jul. 13, 2022, the contents of which are hereby incorporated by reference in its entirety.

### TECHNICAL FIELD

The present disclosure relates to doors, seating, and ways in which doors can be configured such that the user and/or sitter is able to make use of space while being provided with easy ingress and egress.

### BACKGROUND

Doors of any vehicle used to transport people, goods, or cargo may not allow the transported passengers to make use of space. Many times, doors adjacent to seats are difficult to traverse and such doors do not have accommodations for comfort. Such a lack of accommodations may lead to discomfort and ergonomic hardships including posture difficulties and pain as a user has to dip under an upper vehicle lip, step over a lower vehicle lip, and simultaneously position the user's body into a vehicle seat. It is desirable to have secure doors that provide for space usage within a cabin while providing for ingress, egress, and comfort accommodations.

For aircraft, there is also a need to keep doors as light as possible and to avoid wing or wing structures associated with the aircraft when the doors open. The combination of different needs for an aircraft, as well as the aforementioned user comfort and egress/ingress, makes it desirable for a new door design. Although aircraft have a particular need, there exists a need to space and provide additional features in the seats, seat backs, seat frames and seat shrouds in most vehicles-including wagons, bicycles, motor vehicles (e.g., motorcycles, cars, trucks, and/or buses), railed vehicles (trains, trams), watercraft vehicles (ships, boats, and/or underwater vehicles), amphibious vehicles (screw-propelled vehicles and/or hovercrafts), aircraft (airplanes, helicopters, aerostats), and/or spacecraft, among others—to ensure functionality and comfort for the transported people and/or passengers. In such a manner, the passenger(s) makes use of the seat space during travel.

### SUMMARY

Differing from conventional solutions, the disclosed seat apparatus solves vehicle space and comfort problems by providing a unique door for a vehicle that integrates one or more features of: an upward-opening upper door, a fold-out lower door including a ramp or stair, an integrated armrest in the fold-out lower door, lighting in the fold-out lower door for ease of ingress and egress, and lighting in the fold-out lower door and/or upward-opening upper door, thereby allowing for use of cabin space, ergonomically friendly features, comfort, and simplifying ingress and egress of the vehicle.

In a first example embodiment a vehicle is disclosed. The vehicle includes a body forming a door opening. The vehicle also includes a first hinge coupled to the body. The vehicle further includes a door coupled to the body at the door opening and movable between an open position and a closed position. The door includes a first door portion comprising a first end and a second end opposite the first end. The first end is coupled to the first hinge and configured to rotate in a first direction in the open position and the second end is coupled to a second hinge. The door also includes a second door portion coupled to the second hinge and configured to rotate at an angle to the first door portion in the open position and form a single surface with the first door portion in the closed position.

In an embodiment, the rotation of the second door portion occurs simultaneously with the rotation of the first door portion.

In an embodiment, a rate of rotation of the second door portion is determined by one or more sensors located on the second door portion.

In an embodiment, the vehicle further includes a cable coupled to the second door portion. As the first door portion rotates in the first direction the cable pulls on the second door portion to cause the second door portion to rotate.

In an embodiment, the vehicle further includes an alert signal configured to indicate to a user when the door is closing or opening.

In such an embodiment, the indication comprises at least one of an audible indication, a visual indication, or an audible and visual indication.

In an embodiment, the first door portion further includes a window configured to be an emergency exit.

In such an embodiment, the window spans more than one row of seating disposed within the vehicle.

In an embodiment, a length of the second door portion is less than a length of the first door portion.

In a second example embodiment a method for actuating a door coupled to a door opening, where the door comprises a first door portion and a second door portion, is disclosed. The method includes disengaging a latch securing the door to the door opening. The method also includes rotating, by actuating a first hinge coupling the first door portion to the door opening, the first door portion in a first direction. The method further includes rotating, simultaneously with the rotation of the first door portion, the second door portion at an angle to the first door portion such that a length of the door in an open position is less than a closed position. The second door portion is coupled to the first door portion at a second hinge. The method additionally includes lockingly engaging the door in the open position.

In an embodiment, the method further includes disengaging the door in the open position. The method includes rotating, by actuating the first hinge, the first door portion a second direction opposite the first direction. The method includes rotating, simultaneously with the rotation of the first door portion, the second door portion to form a single surface with the first door portion in the closed position. The method includes engaging the latch securing the door in the door opening.

In an embodiment, the method of rotating the second door portion further includes determining, by way of a sensor, a distance between the second door portion and a structure. The method of rotating the second door portion also includes beginning rotation of the second door portion when the distance between the second door portion and the structure is less than a threshold distance.

In a third example embodiment a vehicle is disclosed. The vehicle includes a body forming a door opening. The vehicle also includes a first hinge coupled to the body. The vehicle further includes a second hinge coupled to the body. The vehicle additionally includes a door coupled to the body at the door opening. The door includes a first door portion coupled to the first hinge and configured to rotate open in a first direction. The door also includes a second door portion coupled to the second hinge and configured to rotate open in a second direction opposite the first direction. The first door portion is configured to securingly engage the second door portion.

In an embodiment, the second door portion further comprises one or more steps.

In such an embodiment, the one or more steps are configured to rotate automatically during actuation of the second door portion between a first position and a second position. The one or more steps are flat against the second door portion in the first position and form an angle with the second door portion in the second position.

In an embodiment, the door opening spans more than one row of seating disposed within the vehicle.

In an embodiment, the second door portion further comprises a ramp.

In an embodiment, the second door portion further comprises an armrest available to a user when the second door portion is engaged with the first door portion.

In an embodiment, the first door portion and the second door portion are operably coupled to a controller. The controller causing rotation in the first door portion and the second door portion upon pressing of a button.

In an embodiment, the first door portion and the second door portion comprise a single surface when the door opening is closed.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 illustrates an example of a door for an aircraft as would be known in the prior art.

FIG. 2 illustrates an exemplary embodiment of a door for an aircraft according to embodiments of the present invention.

FIG. 3A illustrates an exemplary embodiment of a door for an aircraft according to embodiments of the present invention.

FIG. 3B illustrates an exemplary embodiment of a door for an aircraft according to embodiments of the present invention.

FIGS. 4A-4G illustrate an exemplary embodiment of an upper door and a lower door that may be included on an aircraft, according to embodiments of the present invention.

FIGS. 5A-5D illustrate an exemplary embodiment of a forward door and an aft door that may be included on an aircraft, according to embodiments of the present invention.

FIGS. 6A-6G illustrate an exemplary embodiment of a door that may be included on an aircraft, according to embodiments of the present invention.

FIGS. 7A-7D illustrate an exemplary embodiment of a door that may be included on an aircraft, according to embodiments of the present invention.

FIG. 8 is a flow chart of an example method for actuating a door coupled to a door opening, according to embodiments of the present invention.

### DETAILED DESCRIPTION

Reference will now be made in detail to exemplary embodiments, shown in the accompanying drawings.

This disclosure relates to doors, seating, and ways in which doors can be configured such that the user and/or sitter is able to make use of space while being provided with easy ingress and egress. Note that the term ‘vehicle’ may encompass a large number of modern vehicles, including wagons, bicycles, motor vehicles (motorcycles, cars, trucks, and/or buses), railed vehicles (trains, trams), watercraft vehicles (ships, boats, and/or other underwater vehicles), amphibious vehicles (screw-propelled vehicles and/or hovercrafts), aircraft (airplanes, helicopters, aerostats), and/or spacecraft, among others. The above list is not, in any manner, supposed to signify a limited list of what the term ‘vehicle’ defines in terms of structure.

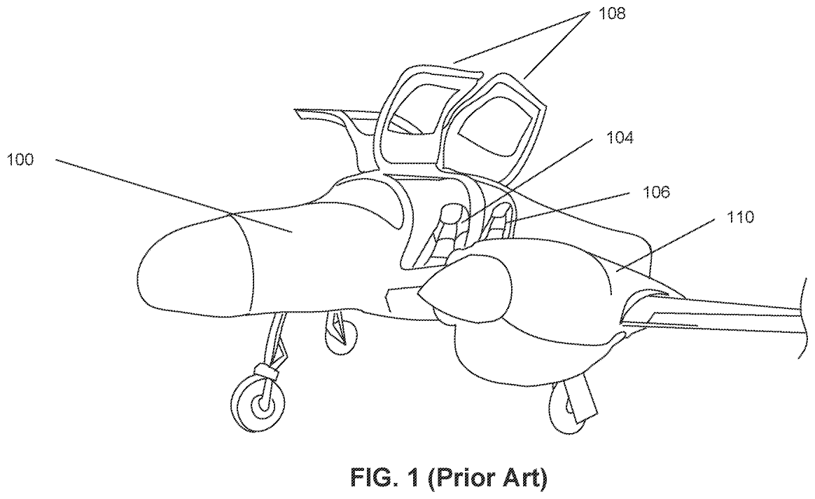

FIG. 1 illustrates an example of a vehicle with a door as would be known in the art prior to this disclosure. As illustrated in FIG. 1, a vehicle 100 can comprise doors 108 to access one or more seats 104, 106. The doors 108 may operate to open and close by moving substantially downward. This design suffers from requiring the use of a wing 110 of an aircraft for ingress and egress, which presents difficulties as the wing is above ground and relatively narrow, requiring a user to balance on the wing during ingress or egress. This is further complicated by the narrow door opening and the need to step over a lower lip of the door opening. Still other designs, where the door opening is accessible from ground level, can be difficult to access from the ground without steps or a ramp. Other designs may incorporate a stair or ramp into the vehicle in a separate compartment along the bottom of the vehicle or within the vehicle, but such stairs require extra space and weight.

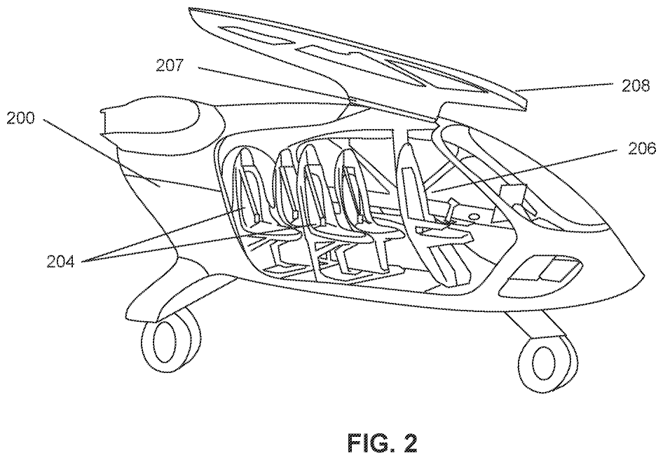

As illustrated in FIG. 2, exemplary embodiments consistent with the present disclosure may include a vehicle 200 having at least one door 208. While a single door is illustrated in FIG. 2, it is contemplated that the vehicle may include any suitable number of doors, including one or more separate doors for a pilot or operator. Door 208 may open vertically to provide access to seats 204, 206. Door 208 may provide access to more than one row of vehicle 200. For example, door 208 may provide access to an operator seat 206 and one or more passenger seats 204. As another example, door 208 may provide access to more than one passenger seats 204. Door 208 may rotate or move about hinge 207. Door 208 may provide access through a door opening to a cabin of vehicle 200. Door 208 may rotate to open or move to open substantially vertically to allow access to the cabin of vehicle 200. In some embodiments, the door 208 may be configured to rotate upward between a wing structure and a side of the vehicle.

In some embodiments, door 208 may be latched anywhere along its periphery or more than one places along its periphery such that door 208 can close the door opening. One or more latches of door 208 may be released from any or more than one of seats 204 or 206. One or more buttons or switches of vehicle 200 may operate to open or close door 208. For example, door 208 may be operable by one or more actuators to open or close. In some embodiments, door 208 may be biased open and when a latch of door 208 is released, door 208 may open.

In some embodiments, door 208 may comprise a seal around its periphery to allow a cabin of vehicle 200 to be closed from an exterior of the vehicle 200. For example, door 208 may be closed to reduce noise in the cabin. In some embodiments, door 208 may be configured to maintain a pressure within the cabin (e.g., a pressurized cabin for high altitude flight).

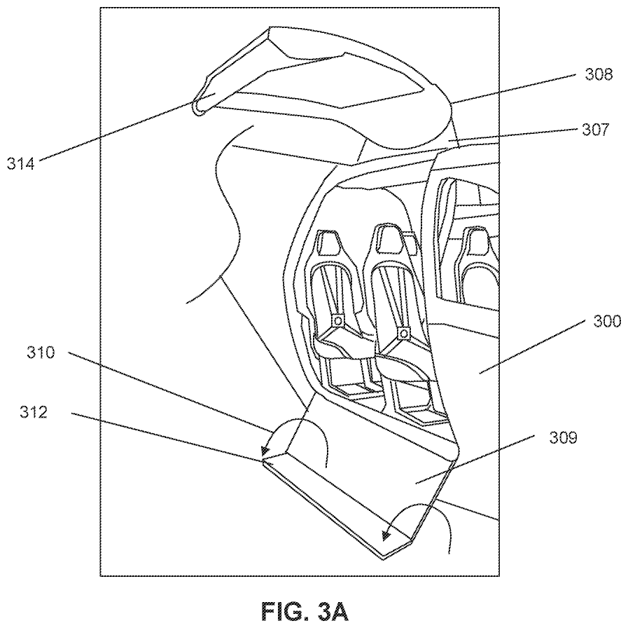

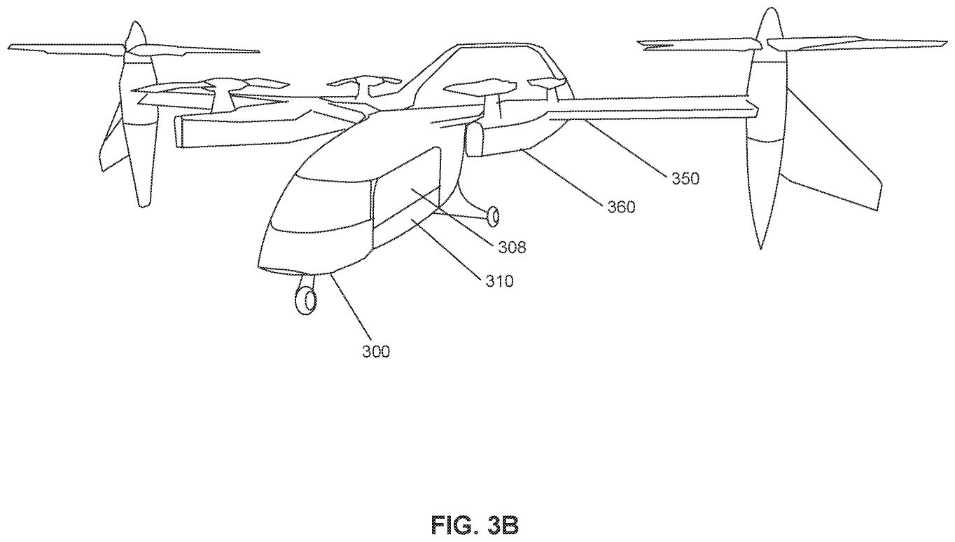

As illustrated in FIG. 3A, exemplary embodiments consistent with the present disclosure include a vehicle 300 that may comprise upper door portion 308 and lower door portion 310. Upper door portion 308 and lower door portion 310 may move to open and close. Upper door portion 308 and lower door portion 310 may also be operable from more than one row. In one example, a passenger may operate either the upper door portion 308 or lower door portion 310 by operating an actuator. In another example, the vehicle operator may press a button to operate either the upper door portion 308, the lower door portion 310, or both.

For example, the upper door portion 308 may rotate about the hinge 307 in a first direction to open and rotate about the hinge 307 in a second direction opposite the first direction to close. Similarly, the lower door portion 310 may rotate about the hinge 309 in a first direction to open and rotate about the hinge 309 in a second direction opposite the first direction to close. In some examples, rotation of the upper door portion 308 may be opposite to rotation of the lower door portion 310. For example, the upper door portion 308 may rotate open in the first direction (e.g., upward) and the lower door portion 310 may rotate open in a direction opposite the first direction (e.g., downward).

Upper door portion 308 may latch in one or more places to lower door portion 310 and/or a door frame of vehicle 300 to close. Latching the door during vehicle movement may prevent the door from opening. Lower door portion 310 may latch in one or more places to upper door portion 308 and/or a door frame of vehicle 300 to close. Upper door portion 308 and lower door portion 310 may each comprise a handle that may open or close either the upper door portion 308 or the lower door portion 310. The handle may be operable by a passenger from more than one row. In some embodiments, the upper door portion 308 and/or the lower door portion 310 may each comprise a plurality of handles, such as at least one handle per row, that may be operable by a passenger.

In some embodiments, upper door portion 308 and lower door portion 310 may not require sealing against a raised door lip surrounding the door opening. Without a raised door lip, ingress and egress into vehicle 300 may be simplified by reducing the need for an operator or passenger to step over or duck under the raised door lip.

In some embodiments, upper door portion 308 may comprise an armrest 314 such that it is usable as an armrest 314 or one or more seats when upper door portion 308 closes over a door opening.

In some embodiments, lower door portion 310 may comprise a panel 312 that can fold out when lower door portion 310 is in an extended position (e.g., open position). Panel 312 may be used as a stair/step when it is in an extended position. In some embodiments, panel 312 may rotate to an extended position when lower door portion 310 is in the extended position. In some embodiments, panel 312 may rotate automatically to open and/or close, however in other embodiments rotation of the panel 312 may be manually actuated. In some embodiments, panel 312 or lower door portion 310 may comprise a ground support that holds panel 312 and/or lower door portion 310 off the ground. Non-limiting examples of ground supports may include legs, pegs, knobs, or any other object that may support weight and prevent movement. In some embodiments, panel 312 and/or lower door portion 310 may be suspended off the ground in an extended position (e.g., where a user can access one or more seats of vehicle 300).

In some embodiments, lower door portion 310 may comprise an armrest. In some embodiments, panel 312 may be an armrest when lower door portion 310 is closed and a stair when lower door portion 310 is open. Lower door portion 310 may also comprise a ramp when open.

In some embodiments, vehicle 300 may comprise an alert that sounds when lower door portion 310 and/or upper door portion 308 move to open and/or close.

As illustrated in FIG. 3B, exemplary embodiments consistent with the present disclosure may include a vehicle 300 that can comprise upper door portion 308 and lower door portion 310 that close about a cabin. FIG. 3B illustrates upper and lower door portions 308, 310 latched, locked, or affixed to each other by way of a pinned connection, a latch, or any other connection known to one of ordinary skill in the art. In some embodiments, the upper and/or the lower door portions 308, 310 may comprise a lock configured to keep the upper and lower door portions together during vehicle operation, and may also unlock when the vehicle lands or in the event of an emergency. The lock may be operable by a passenger in more than one row.

In some embodiments, upper door portion 308 may rotate and avoid a wing structure such as boom 360 or wing 350. The design of upper door portion 308 may be such that it rotates or moves between boom 360 and a side of vehicle 300. For example, a length of upper door portion 308 may be shorter than a length of the lower door portion 310 to allow rotation of the upper door portion 308 between the boom 314 and the side of the vehicle 300. In some embodiments, upper door portion 308 may be offset from, such as positioned in front of, the wing 350 such that it can rotate or move between an open position and a closed position without impinging wing 350. In some embodiments, upper door portion 308 may be positioned beneath wing 350 such that it can rotate or move between an open position and a closed position without impinging wing 350. In some embodiments, upper door portion 308 may be latched to boom 360 or wing 350 to stay in an open position.

For example, the boom 360 and/or the wing 350 may comprise a latching mechanism that is capable of receiving a latching device on the upper door portion 308. When the upper door portion 308 is in the opened position, the latching mechanism may engage the latching device on the upper door portion 308 to secure the upper door portion 308 in the open position. However, in other embodiments, the upper door portion 308 may utilize other systems for maintaining an open position, such as a gas spring.

In some embodiments, upper door portion 308 and lower door portion 310 may close to form an outer surface along a side (e.g., a fuselage) of vehicle 300. In some embodiments, the surface may be relatively smooth in order to reduce drag on vehicle 300. For example, when closed, the upper and lower door portions 308, 310 may form an aerodynamic surface of the vehicle 300.

In some embodiments, the upper door portion 308 may comprise one or more windows. The one or more windows may be rounded along a portion of the perimeter, such as at corners, to reduce stress concentration factors. In some embodiments, the one or more windows may include a latch or mechanism that allows a user to remove the window. For example, in the event of an emergency, the one or more windows may be removable and function as an emergency egress from the vehicle 300. The one or more windows may be configured for pressurization of the cabin of the vehicle 300.

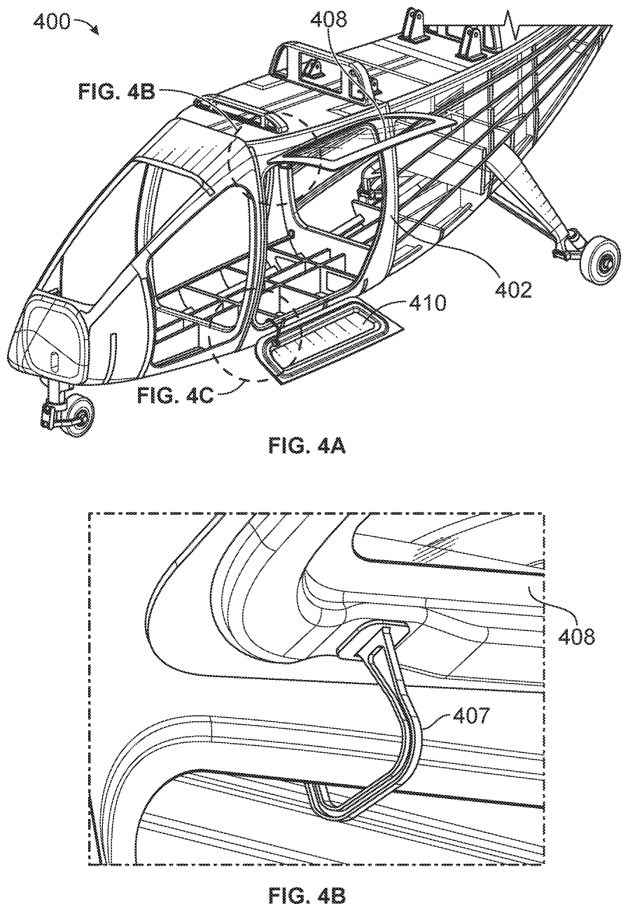

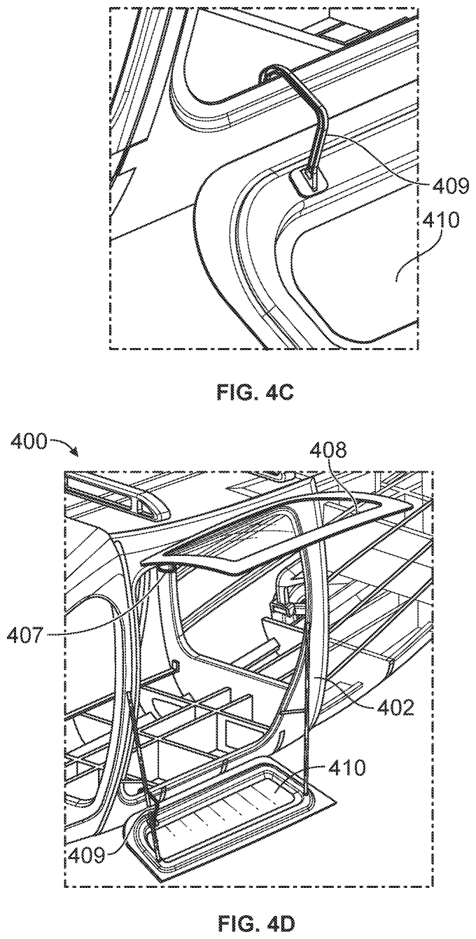

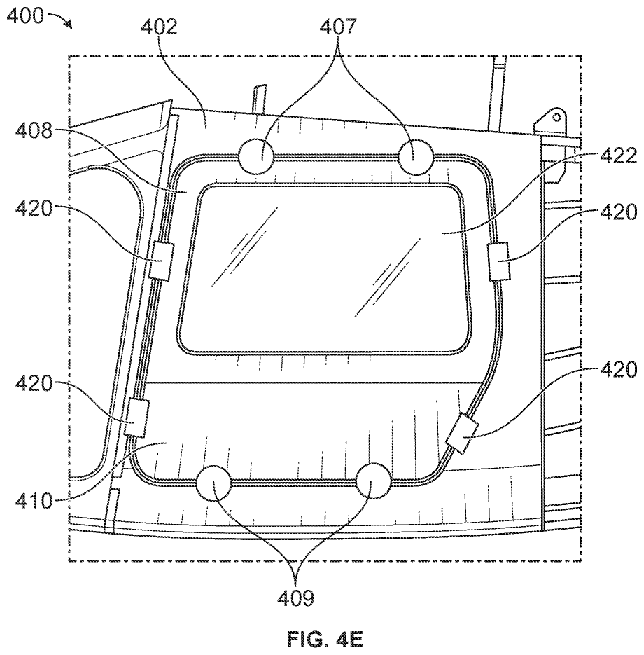

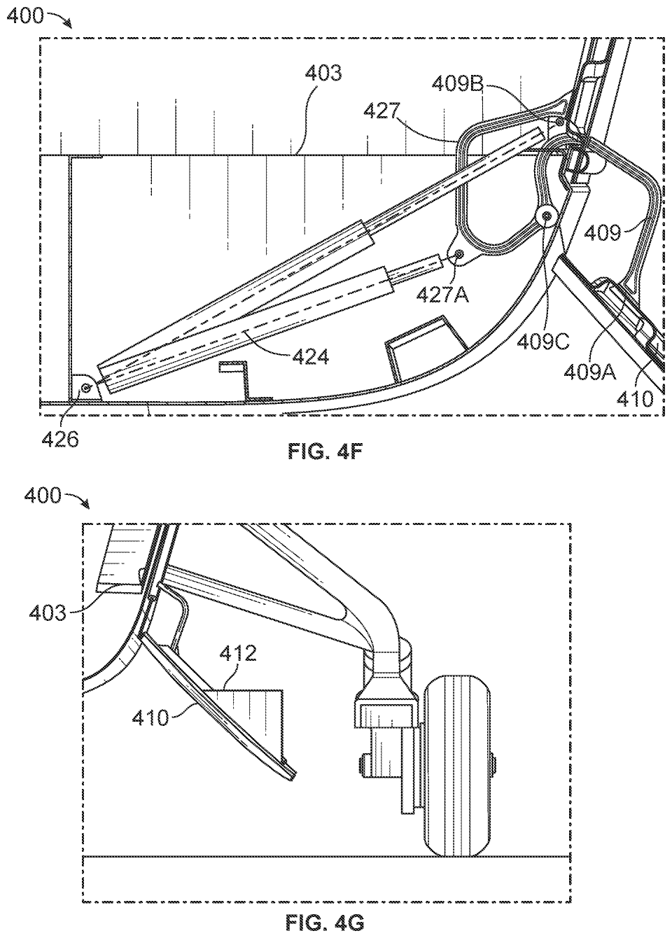

FIGS. 4A-4G illustrate an upper door 408 and a lower door 410 that may be included on an aircraft 400, according to an exemplary embodiment of the present invention. As shown in FIG. 4A, the upper and lower door 408 and 410 are in an open position on the aircraft 400. The upper door 408 may be disposed on an opposite side of a door frame 402 as the lower door 410. In some examples, the upper door 408 may open in an opposite direction as the lower door 410. For example, the upper door 408 may open upward on the aircraft 400 and the lower door 410 may open downward on the aircraft 410. Opening upward may allow the upper door 408 to function as an awning when in the open position. The awning may provide relief to a user entering and/or exiting the aircraft 400 during events of precipitation, such as rain or snow. Opening the lower door 410 downward may allow the lower door 410 to function as a ramp. The ramp may allow for easier entering and/exiting of the aircraft 400 by the user. For example, the door frame 402 may be disposed above ground level at a distance that may require assistance to access. The ramp may compensate for the distance to allow the user access to the aircraft 400 without incurring difficulty. In some examples, the lower door 410 may contact the ground in the open position. However, in other examples the lower door 410 may include a support, such as a brace or leg, that contacts the ground in the open position.

To facilitate opening and closing the upper and lower doors 408 and 410 may couple with a hinge 407 and 409, respectively shown in FIGS. 4B and 4C. As shown in FIG. 4D the hinge 407 may couple the upper door 408 to the door frame 402. The hinge 409 may couple the lower door 410 to the door frame 402 on the opposite side of the door frame 402 as the upper door 410. The hinges 407 and 409 may couple to an internal portion of the door frame such that in a closed position the hinges 407 and 409 may be recessed within the aircraft 400. Recessing the hinges 407 and 409 within the aircraft 400 may produce improved aerodynamics compared to externally disposed hinges. Further, recessing the hinges 407 and 409 may produce a more enjoyable experience for a passenger by reducing the likelihood of tripping over a hinge jutting into the cabin.

In some examples, the upper door 408 may be a first door and the lower door 410 may be a second door. The hinge 407 may allow the upper door 408 to rotate open and close in an upward direction and the hinge 409 may allow the lower door 410 to open and close in a downward direction. Thus, in some examples the first door may rotate open in a first direction and the second door 410 may rotate open in a second direction opposite the first direction.

FIG. 4E shows the upper and lower doors 408 and 410 in the closed position on the aircraft 400. In some examples, the upper door 408 may mate with the lower door 410 in the closed position. For example, the first door 408 may couple with the hinge 407 a first end and mate with the second door 410 at a second end. The second end of the upper door 408 may be opposite the first end. Similarly, the second door 410 may couple with the hinge 409 at a first end and mate with the first door 408 at a second end. The second end of the lower door 410 may be opposite the first end. In the closed position, the upper door 408 and the lower door 410 may form a single surface, such as an exterior surface on the aircraft 400. Forming a single surface in the closed position may provide increased aerodynamic efficiency by reducing drag at the mating location. Thus, in some examples the single surface formed by the upper and lower doors 408 and 410 may be an aerodynamic surface.

In some examples, the upper door 408 and the lower door 410 may not overlap one another in the closed position. However, in other examples a portion of either the upper or lower door 408 or 410 may overlap a portion of the other door in the closed position. For example, the upper door 408 may include a lip that overlaps a portion of the lower door 410, configured to receive the lip, in the closed position. In some examples, the first door 408 may be configured to securingly engage the second door 410.

In some examples, the upper door 408 may include a window 422. A dimension of the window may span more than one row of seating. For example, the window 422 may be proximate to passengers seated in multiple rows on the aircraft 400. In some examples, the window 422 may be configured to be an emergency exit. An emergency exit spanning multiple rows may increase evacuation efficiency by allowing more than one row access to the exit.

As shown, in the closed position one or more latches 420 may secure the upper and/or lower doors 408 and 410 to the door frame 402. While the one or more latches 420 are shown on both the upper and lower doors 408 and 410, in some examples only one of the doors may include the one or more latches 420. For example, only the upper door 408 may include the one or more latches 420 or only the lower door 410 may include the one or more latches 420. The one or more latches 420 may be located on any side of the upper and/or lower doors 408 and/or 410. Positioning the one or more latches on opposing sides of the upper door 408 and/or the lower door 410 may provide more secure coupling to the aircraft 400, as well as more effective load transfer through the upper and lower doors 408 and 410.

As shown in FIG. 4F, an actuator 424 may be coupled to the lower door 410. In some examples, rotation of the lower door 410, such as opening and/or closing, may be aided by the actuator 424. For example, the hinge 409 may be fixedly coupled at a first end 409A to the lower door 410 and coupled at a second end 409C to a retaining bracket 427 disposed within the aircraft 400. The second end 409C may form a point of rotation about which the hinge 409 rotates during opening and closing. Thus, the hinge 409 may be rotatably coupled at the second end 409C. In some examples, the hinge 409 may include a flange 409B that couples the hinge 409 to the actuator 424, such as coupling the hinge 409 to an arm of the actuator 424.

In some examples, the actuator 424 may further be fixedly coupled to the aircraft 400. For instance, the actuator may be coupled to a fuselage flange 426 as well as a retaining bracket flange 427A. The actuator 424 may be disposed within the aircraft 400 below a cabin floor 403. In operation, the actuator 424 may exert forces on the flange 409B to cause the hinge 409 to rotate about the second end 409C. For example, as the actuator 424 exerts forces on the flange 409B, the flange 409B may travel about a path (e.g., a track) defined by the retaining bracket 427, rotating about the second end 409C. The travel of the flange 409B may cause the lower door 410 to rotate open and/or closed. In some examples, a portion of the hinge 409 may be recessed within the retaining bracket 427 when the lower door 410 is in the closed position and external of the aircraft 400 when the lower door 410 is in the open position. While FIG. 4F shows the hinge 409 as a gooseneck configuration, other hinges may be used.

In some examples, the actuator 424 may be operably coupled to a controller (e.g., a button) and may open and/or close the lower door 410 upon direction of the controller, such as the user pressing an open or close button. In examples where the lower door 410 is operably coupled to the controller, the upper door 408 may also be operably coupled to the same controller such that the upper and lower doors 408 and 410 may both open and/or close via pressing of the same button.

However, in other examples the lower door 410 may be manually operable to open and/or close. In examples where the lower door 410 is manually operable, the actuator 424 may provide assisted opening and/or closing of the door. For example, the actuator 424 may be a gas spring or other similar structure that offsets a portion of the lower door weight, allowing the user to open and/or close the door using less force than otherwise required. In examples where the lower door 410 is manually operable, the gas spring or other similar structure may control an opening rate of the lower door 410. For example, the gas spring may resist the force of gravity acting on the lower door 410 to allow the lower door 410 to slowly rotate open. Slowly rotating the lower door 410 open may reduce the occurrence of damage to the lower door 410 and/or the aircraft 400.

FIG. 4G shows a step 412 included on the lower door 410. In some examples, a distance between ground level and the cabin floor 403 may make it desirable for the lower door 410 to include the step 412. In some examples, the step 412 may be have a fixed frame while in other examples the step 412 may be retractable and/or collapsible. For example, the step 412 may be configured to deploy when the lower door 410 is in the open position and collapse (e.g., lie flat) against a surface of the lower door 410 when the lower door 410 is in the closed position. In some examples, the step 412 may be mechanically actuated to deploy (e.g., unfold) as the lower door 410 is opening and collapse (e.g., fold) when the lower door 410 is closing. Thus, deployment of the step 412 may be associated with rotation of the lower door 410.

While only one step 412 is shown in FIG. 4G, the lower door 410 may include more than one step. In some examples, the lower door 410 may include a plurality of steps. For example, the lower door 410 may include a plurality of collapsible steps. In such examples, the plurality of steps may be coupled together by way of a rod or similar structure. Actuation of the rod may cause the plurality of steps to rotate to form an angle with the lower door 410. Actuation of the rod in an opposite direction may cause the steps to collapse and lie substantially parallel against the surface of the lower door 410. In some examples, a railing may be coupled to one or more steps to provide support for a user entering and/or exiting the aircraft 400. Including a plurality of collapsible steps on the lower door 410 may provide a compact and efficient method of entering and/or exiting the aircraft 400 while not encroaching on cabin space.

In some examples, the step 412 may be configured to act as a step when the lower door 410 is in the open position and act as an armrest when the lower door 410 is in the closed position. For example, one or more components on the step 412 may be foldable to allow the step 412 to transform into an armrest. In other examples, the step 412 may be cantilevered on the lower door 410 which may allow a first side to function as a step and a second side opposite the first side to function as an armrest. Using the step 412 as both a step and an armrest may allow for multitasking of the part with may reduce the weight of the aircraft 400 and increase flight efficiency.

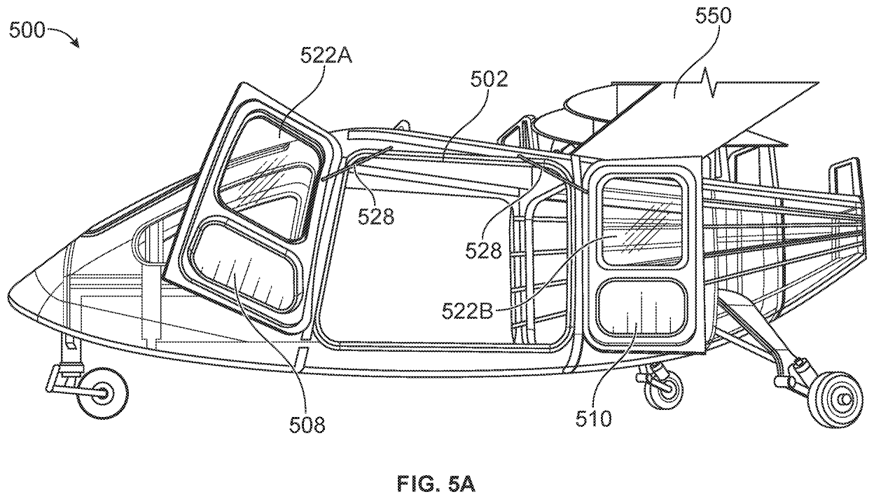

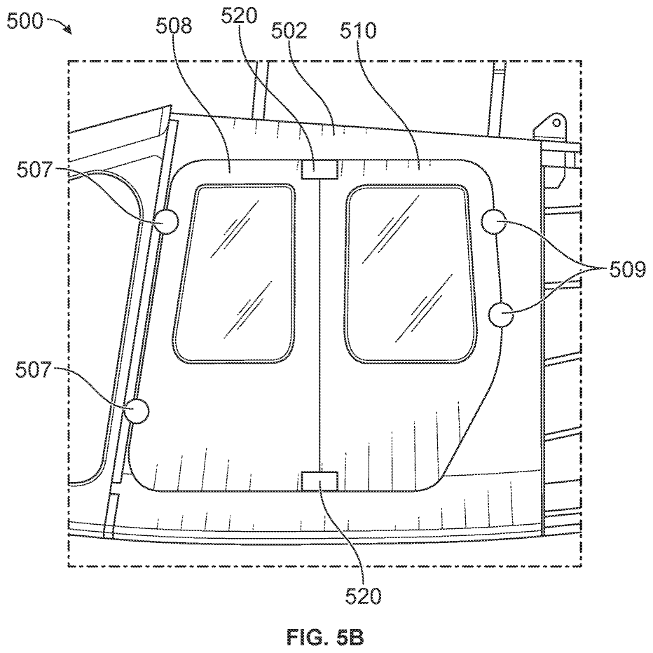

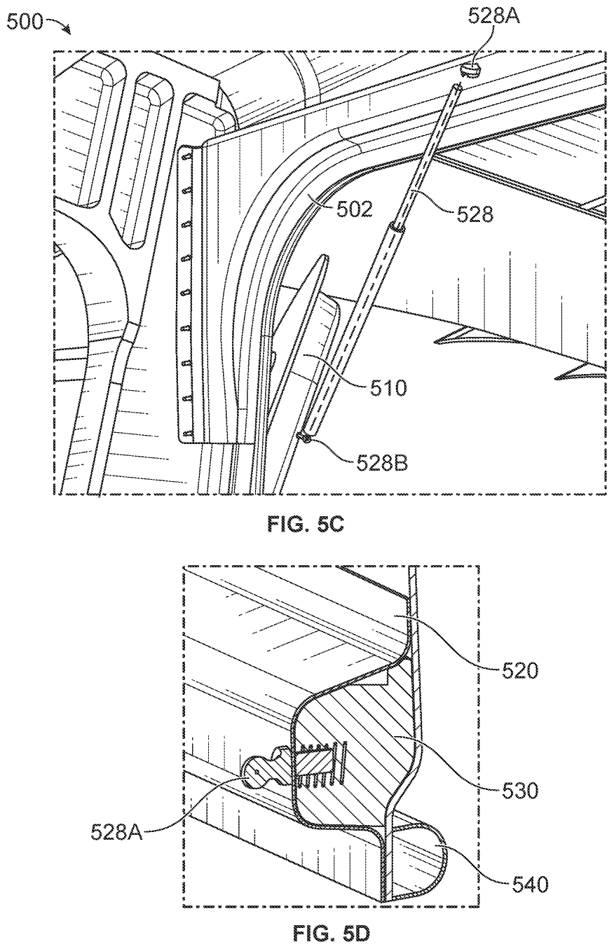

FIGS. 5A-5D illustrate a forward door 508 and an aft door 510 that may be included on an aircraft 500, according to an exemplary embodiment of the present invention.

As shown in FIG. 5A, the aircraft 500 may include the forward door 508 and the aft door 510 coupled to a door frame 502 of the aircraft 500. The forward and aft doors 508 and 510 may each include a window 522A and 522B, respectively. One or more springs 528, such as a gas spring, may be coupled to the door frame 502 and the forward and aft doors 508 and 510.

The forward door 508 may be configured to rotate open in a forward direction and the aft door 510 may be configured to rotate open in an aft direction such that in the open position the aft door 510 does not contact a wing 550 of the aircraft 500. Thus, the forward and aft doors 508 and 510 may rotate in different directions during opening. Rotating the forward and aft doors 508 and 510 in different directions during opening may allow for more open access to the aircraft 500. For example, more than one row of seating may be proximate to the door frame 502 which may allow a passenger easier ingress/egress from their row of seating. Further, by using a multi-door design compared to a single door design, supporting structure such as the one or more springs 528 and/or attachment points to the door frame 502 may be lighter since loading from the door is reduced.

In some examples, the forward door 508 may be a first door and the aft door 510 may be a second door. In such examples, the first door may be configured to rotate open in a first direction, such as the forward direction, and the second door may be configured to rotate open in a second direction, such as the aft direction. In some examples the first direction may be different than the second direction. For instance, the first direction may be opposite to the second direction.

FIG. 5B shows the forward and aft doors 508 and 510 in a closed position on the aircraft 500. The forward door 508 may include hinges 507 and the aft door 510 may include hinges 509. The hinges 507 and 509 may couple the forward and aft doors 508 and 510 to the door frame 502. In some examples, the hinges 507 and 509 may couple to the forward and aft doors 508 and 510 on an internal surface to reduce aerodynamic drag on the aircraft 500. The door frame 502 may include a housing, recessed within the door frame 502, for each of the hinges 507 and 509. In the closed position, the housing may allow for storage of the hinges 507 and 509 to keep the cabin free from obstruction.

As shown, one or more latches 520 may secure the forward door 508 and the aft door 510 in the closed position. In some examples, a portion of the one or more latches 520 may be located on an interior portion of the forward and aft doors 508 and 510. However, in other examples, a portion of the one or more latches 520 may be located on a surface of the forward and aft doors 508 and 510, such as an interior surface. In some examples, the one or more latches 520 may allow the forward and aft doors 508 and 510 to transfer loading between the doors and/or through the door frame 502. Thus, in the closed position the forward and aft doors 508 and 510 may form a structural component of the aircraft 500 and aid in transferring in-flight loading through the structure of the aircraft 500.

As shown, in the closed position the forward and aft doors 508 and 510 may form a single surface on an external portion of the aircraft 500. In some examples, a single surface may be a surface where a contour of the aft door 510 is similar to a contour of the forward door 508 at the mating location, such that when closed the forward and aft doors 508 and 510 function as a single aerodynamic surface. Thus, in some examples the single surface may be an aerodynamic surface. Having the forward and aft doors 508 and 510 function as a single aerodynamic surface may increase efficiency of the aircraft 500 during flight by reducing drag formed at the mating location.

As shown in FIG. 5C, the spring 528 may be coupled to the door frame 502 at a joint 528A and further coupled to the aft door 510 at a joint 528B. The joints 528A and 528B may allow for the spring 528 to transfer loading between the aft door 510 and the door frame 502. FIG. 5D shows the joint 528A coupled to the door frame 502. In some examples, the door frame 502 may include a hard point 530 that the joint 528A may be coupled to. The hard point 530 may be located on an interior portion of the door frame 502. For example, during manufacture a hard point 530 may be coupled to an interior portion of the door frame 502. In some examples, a shape of the hard point 530 may mirror the internal cavity of the door frame 502. The hard point 530 may allow for anchoring of the joint 528A to withstand loading, such as gust loading, from the aft door 510 when in the open position. While the hard point 530 is shown on the door frame 502, in some examples the aft door 510 and/or the forward door 508 may include a hard point 530 for coupling to the joint 528B.

In some examples, the forward door 508 and the aft door 510 may each include the spring 528 and the joints 528A and 528B. In examples, the spring 528 may be a gas spring. The spring 528 may be configured to lockingly engage the forward and aft doors 508 and 510 in the open position to mitigate the doors unintentionally closing during use. For example, as users enter and exit the aircraft 500 the doors 508 and 510 may be locked in the open position via the spring 528 to prevent gusts of wind from closing the doors on a user. During closing, the locking mechanism on the spring 528 may be disengaged to allow for reduced effort in closing the forward and aft doors 508 and 510.

In some examples, the aircraft 500 may further include a seal 540. The seal 540 may be disposed around a portion of and/or all of the door frame 502. The seal 540 may be disposed between the door frame 502 and the forward and aft doors 508 and 510, such that when the doors are in the closed position the seal 540 engages the forward and aft doors 508 and 510. In some examples, the seal 540 may reduce the likelihood of environmental conditions, such as water and/or moisture, from intruding the aircraft 500. In further examples, the seal 540 may reduce outside noise within the aircraft 500. Thus, the seal may provide for a more enjoyable experience during flight by reducing external factors (e.g., environmental and/or noise) experienced by the user(s).

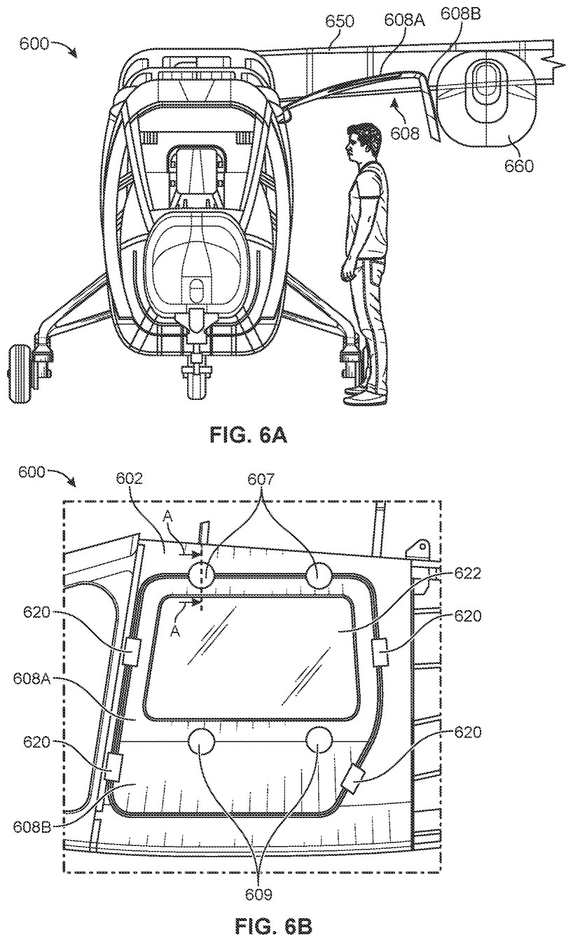

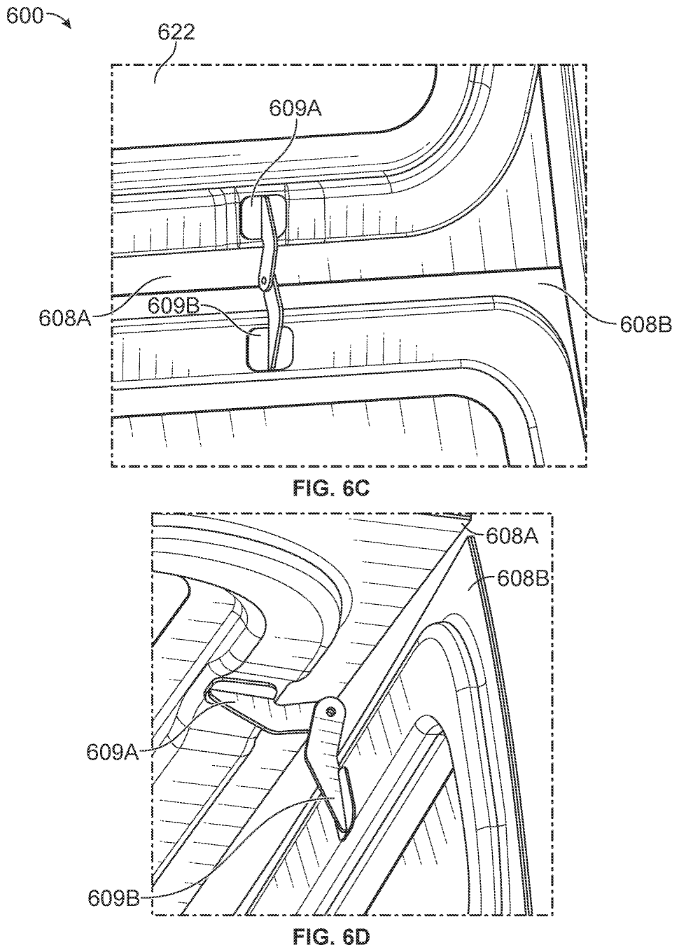

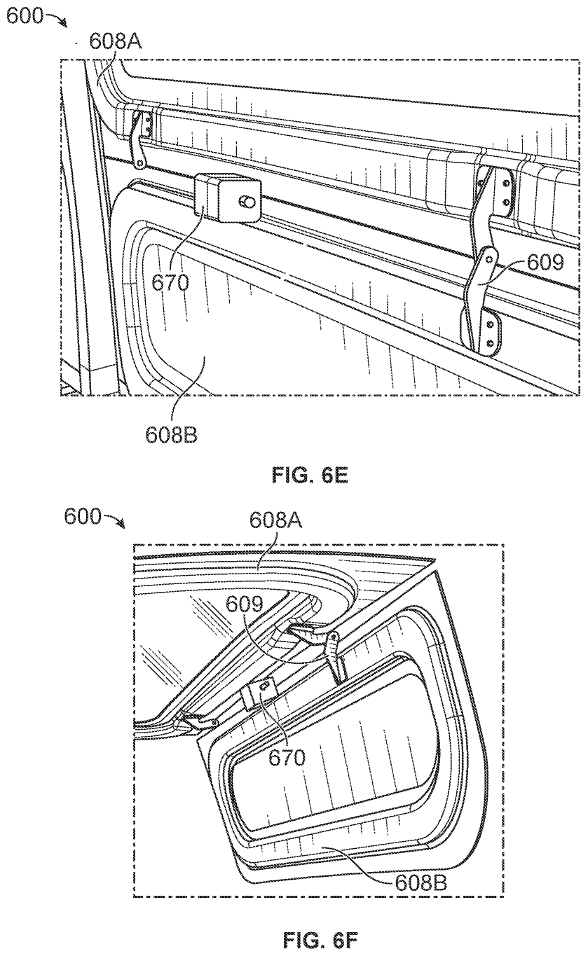

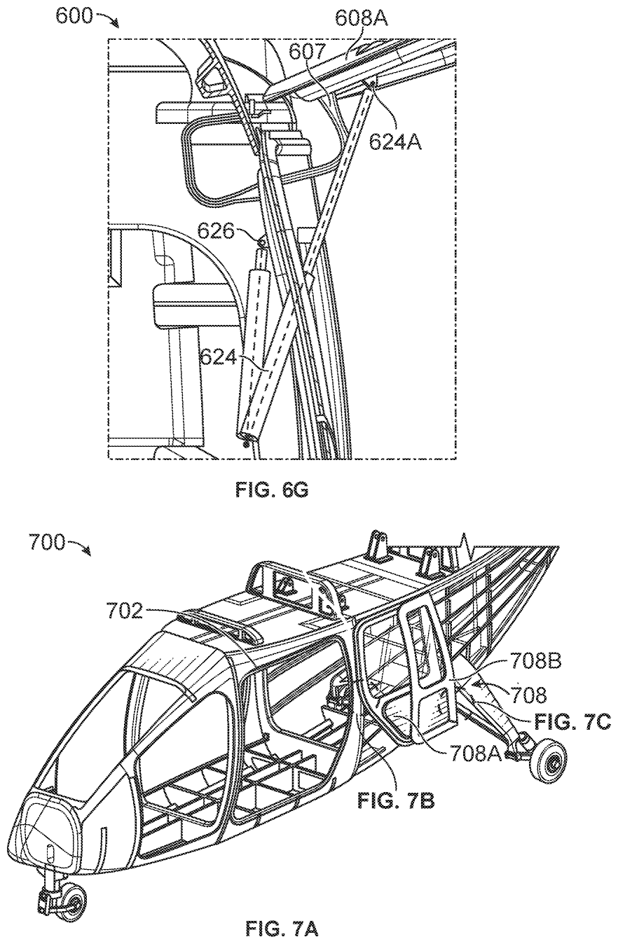

FIGS. 6A-6G illustrate a door 608 that may be included on an aircraft 600, according to an exemplary embodiment of the present invention. As shown in FIG. 6A, the door 608 may include a first portion 608A and a second portion 608B coupled to the first portion 608A. The first portion 608A may rotate upward during opening of the door 608 to allow a user ingress/egress from the aircraft 600. The second portion 608B may be configured to rotate relative to the first portion 608A. For example, the second portion 608B may rotate relative to the first portion 608A such that in an open position the door 608 is disposed inward of a boom 660 coupled to a wing 650 of the aircraft 600. In the open position, an angle between the first and second portions 608A and 608B may be less than an angle between the first and second portions 608A and 608B in a closed position. Thus, in some examples the second portion 608B may be folded towards the first portion 608A in the open position. By rotating the second portion 608B relative to the first portion 608A interference with the boom 660 may be mitigated. This may allow for an upwardly rotating door, such as the door 608, to have more vertical clearance in the open position. In some examples, it may be desirable to include an upwardly rotating door on the aircraft. However, structural constraints of the aircraft, such as the boom and/or the wing, may limit the size and/or positioning of the door. By including a door having a second portion rotate relative to a first portion, a single door may be capable of securing an ingress/egress and opening while effectively navigating the structural constraints.

In some examples, rotation of the door 608 may be automatic. For example, an actuator (e.g., a hydraulic piston) may engage the first portion 608A during opening and/or closing to cause rotation. A second actuator may be coupled between the first portion 608A and the second portion 608B and engage the second portion 608B during opening and/or closing to cause rotation of the second portion 608B relative to the first portion 608A. The actuators may be coupled to a controller, such as a button, and configured to engage the respective first and second portions 608A and 608B upon prompting by the controller.

In some examples, the second portion 608B may rotate simultaneously with rotation of the first portion 608A. For instance, it may be desirable for the second portion 608B to rotate simultaneously with the rotation of the first portion 608A to avoid encountering the boom 660 during opening. In some examples, a timing mechanism may determine a rate at which the actuator engages the second portion 608B. However, in other examples the second portion 608B may include one or more proximity sensors that signal to the actuator to begin rotation of the second portion 608B based on proximity to the boom 660. For example, the one or more proximity sensors may signal to the actuator to begin rotating the second portion 608B towards the first portion 608A (e.g., folding) when a distance between the second portion 608B and the boom 660 is less than a threshold distance. The one or more proximity sensors may signal to the actuator to begin rotating the second portion 608B away from the first portion 608A (e.g., unfolding) when a distance between the second portion 608B and the boom 660 is greater than a threshold distance. Thus, one or more proximity sensors may control actuation of the second portion 608B during opening and closing of the door 608.

In some examples, simultaneous rotation of the second portion 608B may be mechanically determined. For example, one or more cables and/or pulleys may be coupled to the first and second portions 608A and 608B. During opening and closing, as the first portion 608A is actuated the one or more cables may pull on the second portion 608B to cause rotation (e.g., folding) simultaneously with rotation in the first portion 608A. During closing, a spring mechanism (e.g., a hinge or spring) may provide rotation in an opposite direction (e.g., unfolding) as tension in the one or more cables is decreased.

In some examples, the door 608 may serve as an awning in the open position. For example, the door 608 may provide coverage from the sun, as well as precipitation, such as rain or snow, while a user (shown in FIG. 6A) enters and/or exits the aircraft 600. Having the door 608 function as both the door and the awning may increase user enjoyment of the aircraft 600 while also reducing aircraft weight by reducing the need for additional parts.

As shown in FIG. 6B, the aircraft 600 may include the first portion 608A having a window 622, one or more latches 620, hinges 607 coupling the first portion 608A to a door frame 602, and hinges 609 coupling the first portion 608A to the second portion 608B. In some examples, in the closed position the first portion 608A and second portion 608B may be coupled to the door frame 602 of the aircraft 600 by way of the one or more latches 620. For example, the first portion 608A may include the one or more latches 620 coupling the first portion 608A to the door frame 602, and the second portion 608B may include the one or more latches 620 coupling the second portion 608B to the door frame 602. In some examples, the one or more latches 620 may couple the first portion 608A to the second portion 608B. The one or more latches 620 may secure the door 608 to the door frame 602. The one or more latches 620 may facilitate load transfer between the door 608 and the door frame 602 during flight. Utilizing the door 608 as a structural load path for in-flight loading may reduce aircraft weight by reducing supporting structure needed around the door frame 602.

In some examples, the first portion 608A may include the hinges 607 coupling the first portion 608A to the door frame 602. The hinges 607 may allow for rotation of the first portion 608A relative to the door frame 602. For example, the hinges 607 may allow for opening and closing of the door 608 by allowing the first portion 608A to rotate upwardly and downwardly relative to the door frame. In some examples, the first portion 608A may include the hinges 609 coupling the first portion 608A to the second portion 608B. For example, the hinges 607 may be disposed on a first edge of the first portion 608A and the hinges 609 may be disposed on a second edge opposite the first edge.

The hinges 609 may facilitate rotation of the second portion 608B relative to the first portion 608A. For example, the hinges 609 may allow an angle between the first portion 608A and the second portion 608B to change, such as rotating the second portion 608B towards the first portion 608A during opening such that in the open position the angle between the first portion 608A and the second portion 608B may be less than the angle between the first portion 608A and the second portion 608B in the closed position.

In some examples, the closed position may be a first position and the open position may be a second position. In such examples, the first portion 608A may be planar (e.g., continuous, contiguous, and/or in-line) with the second portion 608B in the first position. For example, in the first position the first and second portions 608A and 608B may form a single (e.g., continuous) surface. In the second position the angle between the first and second portions 608A and 608B may be less than the angle between the first and second portions 608A and 608B in the first position. Thus, in some examples the hinges 609 may facilitate rotation of the second portion 608B towards (e.g., folding) the first portion 608A during opening and rotation of the second portion 608B away from the first portion 608A during closing.

While FIG. 6B shows two hinges 607 coupling the door 608A to the door frame 602, any number of hinges 607 may be included on the aircraft 600. In some examples, one hinge 607 may be included, while in other examples three or more hinges 607 may be included. Using one hinge 607 to couple the first portion 608A to the door frame 602 may require a more robust hinge and localized strengthening of the door frame 602 at the coupling location. Whereas using more than one hinge may reduce localized stresses at the hinge locations. Two hinges may provide a balance between design complexity and load distribution at the hinge locations.

FIGS. 6C-6D illustrate the hinge 609 in the closed position and the open position, respectively. As shown, the hinge 609 may be coupled to the first portion 608A at a first end 609A and coupled to the second portion 608B at a second end 609B. In the closed position the hinge 609 may be in an extended state and in the open position the hinge 609 may be in a retracted state. In some examples, when the hinge 609 is in an extended state, a distance between the first and second ends 609A and 609B may be greater than a distance between the first and second ends 609A and 609B in the retracted state. For example, the second end 609B may rotate towards the first end 609A in the open position. In some examples, rotation of the second end 609B towards the first end 609A may facilitate rotation of the second portion 608B relative to the first portion 608A. Thus, in the open position an angle formed between the first and second portions 608A and 608B may be less than an angle formed between the first and second portions 608A and 608B in the closed position. In some examples, the hinge 609 may be a scissor hinge. However, in other examples the hinge 609 may be another type of hinge.

As shown in FIG. 6C, in the closed position the first and second portions 608A and 608B may form a single surface. Forming a single surface in the closed position may provide increased aerodynamics during flight by reducing drag on the aircraft 600. The single surface may also allow for stresses to be more effectively transferred between the first and second portions 608A and 608B.

In some examples, it may be desirable to constrain movement of the second portion 608B in the open position (e.g., when folded relative to the first portion 608A). For example, it may be desirable to constrain the second portion 608B in the open position to mitigate the likelihood of unintentional movement in the second portion 608B which may pose damage to aircraft components (e.g., the boom 660) and/or personnel. In some examples, the first and second portions 608A and 608B may include an arresting mechanism 670, depicted in FIGS. 6E-6F. The arresting mechanism 670 may be coupled at an interface between the first and second portions 608A and 608B. In some examples, the arresting mechanism 670 may be configured to engage the second portion 608B and resist further rotation of the second portion 608B beyond a desired angle. For example, the arresting mechanism 670 may lock the second portion 608B in the folded position when the door 608 is opened. As the door 608 is closed, the arresting mechanism 670 may disengage the lock and allow the second portion 608B to rotate align with the first portion 608A to form a single surface. However, in other examples, the arresting mechanism 670 may not lock the second portion 608B and may instead engage the second portion 608B at a desired angle to resist further rotation. Thus, in some examples the arresting mechanism 670 may be a rotation stop.

In some examples, an actuator, such as the actuator 624 shown in FIG. 6G, may aid in rotation of the first portion 608A. For example, the actuator 624 may be coupled to the aircraft 600 by way of a flange 626 and coupled to the first portion 608B by way of a flange 624A. Movement of the actuator 624, such as extension of a piston, may cause the first portion 608A to open by rotation about the hinge 607. Movement of the actuator 624 in an opposite direction, such as retraction of the piston, may cause the first portion 608A to close by rotation about the hinge 607. While one actuator 624 is shown in FIG. 6G, any number of actuators may be used. Increasing the number of actuators may decrease the size and strength of each actuator while also increasing design complexity of the door 608.

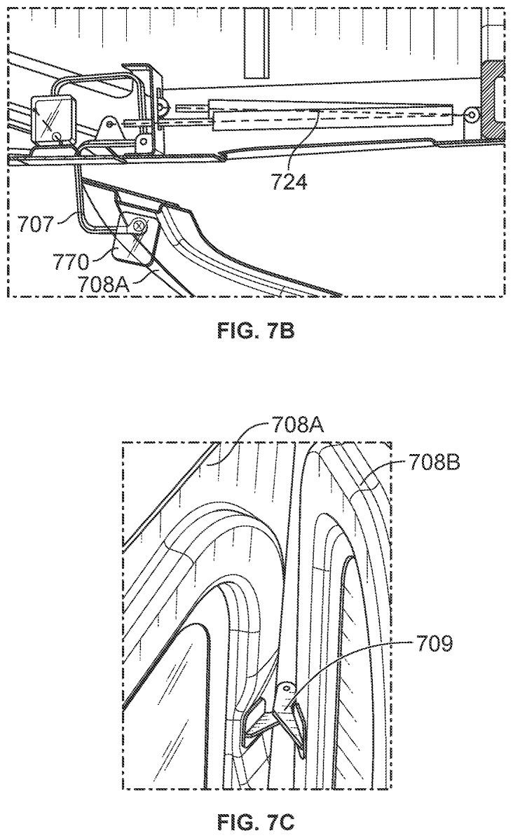

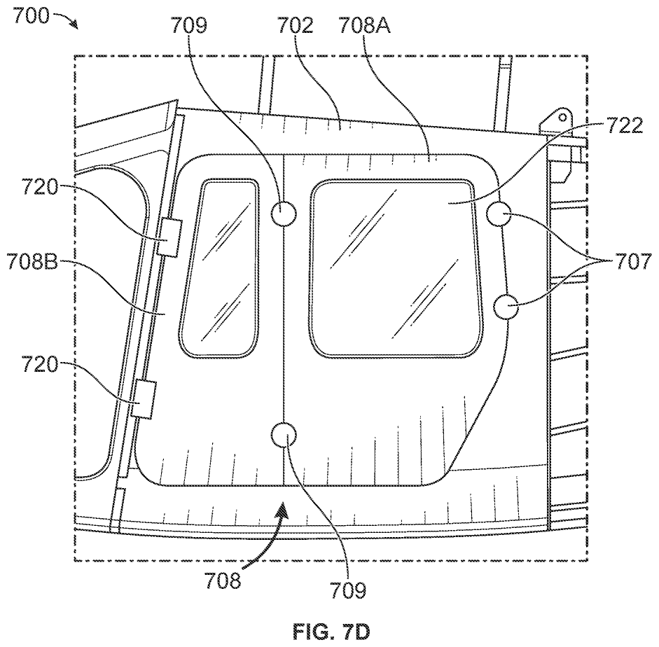

FIGS. 7A-7D illustrate a door 708 that may be included on an aircraft 700, according to an exemplary embodiment of the present disclosure. The door 708 may include a first portion 708A and a second portion 708B coupled to the first portion 708A by way of hinges 709. The first portion 708A may be coupled to a door frame 702 of the aircraft 700 by way of hinges 707. As shown in FIG. 7A, the door 708 is in an opened position. In some examples, the door 708 may be configured to open horizontally on the aircraft 700. For example, the door 708 may open aft of the door frame 702.

In some examples, the first portion 708A may be configured to rotate relative to the door frame 702 to facilitate opening and closing of the door 708. For example, the first portion 708A may rotate about hinges 707 during opening and closing of the door 708. In some examples, the second portion 708B may be configured to rotate relative to the first portion 708A. For example, as the first portion 708A rotates during opening, the second portion 708B may rotate simultaneously with rotation of the first portion 708A. However, in other examples the second portion 708B may begin rotation after the first portion 708A has rotated a threshold distance. In some examples, the second portion 708B may rotate towards the first portion 708A during opening and rotate away from the first portion 708A during closing. For example, in the open position the door 708 may be folded and in the closed position the door 708 may be unfolded. Thus, a length of the door 708 in the open position may be less than a length of the door 708 in the closed position.

In some examples, it may be desirable to include an ingress/egress on the aircraft 700 spanning more than one row of seating so that users may have an easier time entering and exiting the aircraft 700. However, aircraft structure, such as a boom or wing, may pose design constraints which may limit the size and opening direction of the door. By including a foldable door that rotates aft during opening and forward during closing, such as the door 708, it may be possible to include an ingress/egress spanning more than one row of seating while avoiding the aircraft structure.

As shown in FIG. 7B, an actuator 724 may be coupled to the aircraft 700 and the hinge 707. In some examples, the actuator 724 may facilitate opening and closing of the door 708 by engaging the hinge 707 to cause rotation of the first portion 708A about the door frame 702. In some examples, the actuator 724 may function the same or similar to the actuator 624 described with respect to FIG. 6G. For example, linear movement of the actuator 724 in a first direction may cause the first portion 708A to rotate in a first direction, and linear movement of the actuator 724 in a second direction opposite the first direction may cause the first portion 708A to rotate in a second direction opposite the first direction.

FIG. 7C shows a hinge 709 that may couple the first portion 708A to the second portion 708B. In some examples, the hinge 709 may function the same or similar to the hinge 609 described with respect to FIG. 6A-6G. For instance, the hinge 709 may allow the second portion 708B to be folded (e.g., rotated) towards the first portion 708A during opening and unfolded during closing. In some examples, the hinge 709 may allow the second portion 708B to be substantially parallel with the first portion 708A in the open position and substantially planar (e.g., in-line) with the first portion 708A in the closed position.

In the closed position, shown in FIG. 7D, one or more latches 720 may secure the door 708 to the door frame 702. The latches 720 may function the same or similar to the latches 620 described with respect to FIGS. 6A-6G. While the second portion 708B includes the latches 720, in other examples the latches 720 may be located on another portion of the door 708. For example, one or more latches may be located on the first portion 708A and/or located at the convergence of the first and second portions 708A and 708B.

In some examples, a width of the first portion 708A may be greater than a width of the second portion 708B. The width of the first and/or second portions 708A and 708B may be based on a design constraint of the aircraft 700. For example, the width of the first and/or second portions 708A and 708B may be based on a distance from the fuselage to the boom. The first portion 708A may have a width less than a distance from the fuselage to the boom to allow the door 708 to open without contacting the boom. However, in other examples, the width of the first and/or second portions 708A and 708B may be based on another design constraint, such as meeting an emergency exit requirement for a window 722. In such examples, the width of either the first or second portions 708A and 708B may be sized to satisfy the window 722 meeting emergency exit requirements.

In some examples, the door 708 may be configured to rotate (e.g., open and/or close) automatically, while in other examples the door 708 may be manually actuated. Automatic actuation of the door 708 may be the same or similar to automatic actuation of the door 608. Thus, description with respect to automatic actuation of the door 608 may be equally applicable to the door 708.

In some examples, the doors described above with respect to FIGS. 1-7 may be made entirely from a composite material, such as a thermoset or thermoplastic composite. However, in other examples one or more portions of the door may be made from another material, such as metal. For example, a door shell (e.g., interior and exterior surfaces) may be made from a composite material and a portion of the door substructure may be made from metal (e.g., aluminum). In other examples, a portion of the door substructure may include a honeycomb style panel. Further, in some examples the doors may include internally disposed hard points at locations where the door may be coupled to another structure. For instance, the doors may include the hard point where the door couples to a hinge or joint. A shape of the hard point may mirror an internal contour of the door. For example, the hard point may be molded or machined to match the internal contour of the portion of the door that the hard point mates with. In some examples, the hard point may be made from a phenolic polymer or polyamide-imides. The internally disposed hard points may aid in displacing loads from the coupling structure which may mitigate damage to the door. Utilizing the composite material in the door may allow the door to be lighter than using another material, as metal. The lighter door may increase aircraft efficiency during flight as well as reduce the weight of supporting structure needed to actuate and/or support the door.

In some examples, one or more of the doors may be a structural door; while in other examples one or more of the doors may be non-structural. The structural door may facilitate the transfer of loads experienced during flight through the door and to the aircraft structure. Thus, in some examples the one or more doors may act as a load path for in-flight loading. Utilizing the one or more doors as a structural door may reduce stresses on supporting structure, such as the door frame, as loads may not need to entirely transfer around the door opening during flight.

In some examples, the doors may include one or more latches that couple the door to the door frame. The one or more latches may be configured to secure the doors to the aircraft such that during flight the doors and the aircraft body may function as a single structure. Thus, in some examples the one or more latches may facilitate the transfer of loading from the aircraft structure through the door. The one or more latches may include a fastener (e.g., pins, rods, and hooks) that engages the door with the door frame when in the closed position. For example, the one or more latches may include retractable rods that couple with a receiving portion on the door frame. The one or more latches may engage with the door frame to fixedly couple the door in the closed position then disengage with the door frame to allow opening of the door.

Any number of latches may be included on the doors. In examples where the door includes multiple portions, such as a first portion and a second portion, each respective portion of the door may include one or more latches. In some examples, only the first portion may include the one or more latches, only the second portion may include the one or more latches, or both the first and second portions may include the one or more latches. Further, in some examples the one or more latches may be included at a convergence between a first portion and a second portion of the door. In examples where the aircraft includes a first door and a second door, either and/or both doors may include the one or more latches coupling the respective door to the door frame. In some examples, the one or more latches may couple the first door to the second door in the closed position. Coupling the first door to the second door in the closed position may allow the first and second door to form a rigid structure and act as a single unit when transferring loads. Coupling the first door to the second door may also mitigate the unintentional opening of either door during flight.

In some examples, the one or more latches may automatically engage and disengage the door with the door frame. For example, the one or more latches may be communicably coupled to a controller (e.g., a button). Actuation of the controller, such as by pressing the button, may cause the latches to engage and/or disengage the door with the door frame. However, in other examples the one or more latches may be manually actuated to engage and/or disengage with the door frame.

In some examples, one or more of the doors and/or door portions may include a hinge. For instance, the hinge may couple the door to the door frame or the hinge may couple a first door portion to a second door portion. The hinges may provide a point of rotation for the door and/or the door portion. For example, the hinge may facilitate rotation of the door relative to the door frame. The hinges may also facilitate rotation of a second door portion relative to a first door portion. In some examples, the hinges may couple with an actuator and/or spring which may assist the hinge with rotation of the door and/or door portion.

In some examples, a gooseneck hinge may be used to couple the door to the door frame. The gooseneck hinge may allow for the hinge to couple on a first end to a portion of the aircraft below the cabin floor and couple on a second end to the door, while still allowing the hinge to circumvent the door frame. Coupling the hinge below the cabin floor may allow the hinge to be partially recessed under the cabin floor when the door is in the closed position. Partially recessing the hinge may reduce obstacles disposed on the cabin floor which may mitigate passengers tripping over the hinge and/or damaging the hinge. However, other hinges may also be used.

In some examples, a scissor hinge may be used where the second door portion rotates relative to the first door portion. For example, the scissor hinge may allow for the second door portion form an angle with the first door portion in the open position and form a continuous surface with the first door portion in the closed position. In other examples, the scissor hinge may provide for rotation of the second door portion between 0 and 180 degrees relative to the first door portion. For example, it may be desirable to fold the second door portion so that a surface of the second door portion faces a surface of the first door portion. The scissor hinge may facilitate rotation of the second door portion such that the surface faces the first door portion. Allowing for folding of 180 degrees may allow for the total door length to be reduced. Reducing total door length may enable a larger door to be included on an aircraft while not interfering with other aircraft structure, such as a wing or boom. However, in other examples another type of hinge may be used.

In some examples, one or more of the doors may include a window. For example, where the aircraft includes a first door and a second door, each of the respective doors may include the window. However, in other examples only one of the doors may include the window. In examples where the aircraft includes the door having the first portion and the second portion, each respective portion may include the window or only one of the respective portions may include the window. In some examples, the window may be rounded along a portion of the perimeter, such as at corners, to reduce stress concentration factors. In some examples, the window may be configured as an emergency exit. For example, a dimension of the window may be based on a federal regulation pertaining to emergency exit dimensional requirements. In examples where the window is an emergency exit, the window may be removably coupled to the door so that the user may push the window outward from the aircraft to exit in an emergency. For example, the window may include a latch or mechanism that allows a user to remove the window.

In some examples, the window may span more than one row of seating such that the same window is proximate to multiple rows of seats. A large window may allow for greater visibility and user enjoyment. In examples where the window is configured to be an emergency exit, the large window may provide safer and/or expedited egress from the aircraft in the event of an emergency.

In some examples, one or more of the doors may include an alert signal. The alert signal may be configured to indicate to the user when the one or more of the doors are closing or opening. For example, the one or more doors may be communicably coupled with a communication system, such as a speaker or a light. When it is determined that the one or more doors may be rotating open and/or closed the communication system may be triggered to being projecting the alert signal until rotation of the one or more doors has ceased. For example, when the one or more doors reach a fully opened position or fully closed position the alert signal may be terminated. The alert signal may provide an indication to the user that movement may be occurring in the one or more doors. In some examples, the indication may be an audible indication (e.g., a noise), while in other examples the indication may be a visual indication (e.g., a flashing light). In further examples, the indication may be both an audible indication and a visual indication. Indicating movement, such as rotation, of the one or more doors may mitigate the risk that the user is injured by the moving door, thus increasing overall safety of the aircraft.

In some examples, one or more of the doors or door portions may include a light. For example, the light may be included on the first door, the second door, the first portion, and/or the second portion. The light may be configured to turn on and/or off based on a position of the door. For example, the light may turn on when the door begins to open and stay of for the duration of the time the door is in the open position. The light may turn off when the door is in the closed position. In some examples, the light may be coupled to the respective door and/or door portion such that the light may be disengaged (e.g., off) in the closed position and engaged (e.g., on) when the door and/or door portion is not in the closed position. For example, the light may be controllably coupled with a depressible switch located at an interface of the door frame and the door. In the closed position the switch may be depressed and the light may be off. As the door begins to open the switch may become un-depressed and the light may turn on. In some examples, more than one light, such as a row of lights, may be included on a door and/or a door portion. For example, a first door may have a row of lights that illuminate a ramp or step and a second door may have an overhead light to illuminate an area above the ingress/egress.

FIG. 8 is a flow chart of an example method 800 for actuating a door coupled to a door opening, according to exemplary embodiments of the present disclosure. In some examples, the door may include a first door portion and a second door portion. The method 600 may be performed on the door 608 in FIGS. 6A-6G, and/or the door 708 in FIGS. 7A-7D, for example. The method 800 may include one or more operations, or actions as illustrated by one or more steps 802-808. Although the steps are illustrated in a sequential order, these steps may in some instances be performed in parallel, and/or in a different order than those described herein. Also, the various blocks may be combined into fewer steps, divided into additional steps, and/or removed based upon the desired implementation.

As illustrated, at step 802, the method 800 may include disengaging a latch securing the door to the door opening.

At step 804, the method 800 may include rotating, by actuating a first hinge coupling the first door portion to the door opening, the first door portion in a first direction.

At step 806, the method 800 may include rotating, simultaneously with the rotation of the first door portion, the second door portion at an angle to the first door portion such that a length of the door in an open position is less than a closed position. The second door portion may be coupled to the first door portion at a second hinge.

At step 808, the method 800 may include lockingly engaging the door in the open position.

In some examples, rotating the second door portion may further include determining, by way of a sensor, a distance between the second door portion and a structure. Rotating the second door portion may also include beginning rotation of the second door portion when the distance between the second door portion and the structure is less than a threshold distance.

In some examples, the method 800 may further include disengaging the door in the open position. The method 800 may also include rotating, by actuating the first hinge, the first door portion a second direction opposite the first direction. The method 800 may additionally include rotating, simultaneously with the rotation of the first door portion, the second door portion to form a single surface with the first door portion in the closed position. The method 800 may also include engaging the latch securing the door in the door opening.

The term “substantially,” as used herein, may mean exact or deviations from exact, such as intentional and/or unintentional deviations (e.g., manufacturing tolerances). In some examples, “substantially” may indicate one standard deviation from exactly, or two standard deviations from exactly. For example. “substantially” may mean a deviation from exactly between 0 and 10 percent, between 10 and 20 percent, between 30 and 40 percent, or between 40 and 50 percent. In other examples, “substantially” may mean a deviation from exactly between 0 and 10 degrees, between 10 and 20 degrees, between 20 and 30 degrees, between 30 and 40 degrees, or between 40 and 50 degrees.

It will be apparent to persons skilled in the art that various modifications and variations can be made to disclosed vehicle structure. While illustrative embodiments have been described herein, the scope of the present disclosure includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the present disclosure. It is intended, therefore, that the specification and examples be considered as exemplary only, with a true scope and spirit of the present disclosure being indicated by the following claims and their full scope of equivalents.

What is claimed is:

1. A vehicle comprising:
a body forming a door opening;
a first hinge coupled to the body;
a door coupled to the body at the door opening and movable between an open position and a closed position, wherein the door comprises:
a first door portion comprising a first end and a second end opposite the first end, wherein the first end is coupled to the first hinge and configured to rotate in a first direction in the open position and the second end is coupled to a second hinge; and
a second door portion coupled to the second hinge and configured to rotate at an angle to the first door portion in the open position and form a single surface with the first door portion in the closed position.

2. The vehicle of claim 1, wherein the rotation of the second door portion occurs simultaneously with the rotation of the first door portion.

3. The vehicle of claim 1, wherein a rate of rotation of the second door portion is determined by one or more sensors located on the second door portion.

4. The vehicle of claim 1, further comprising a cable coupled to the second door portion, wherein as the first door portion rotates in the first direction the cable pulls on the second door portion to cause the second door portion to rotate.

5. The vehicle of claim 1 further comprising an alert signal configured to indicate to a user when the door is closing or opening.

6. The vehicle of claim 5, wherein the indication comprises at least one of an audible indication, a visual indication, or an audible and visual indication.

7. The vehicle of claim 1, wherein the first door portion further comprises a window configured to be an emergency exit.

8. The vehicle of claim 7, wherein the window spans more than one row of seating disposed within the vehicle.

9. The vehicle of claim 1, wherein a length of the second door portion is less than a length of the first door portion.

10. A method for actuating a door coupled to a door opening, wherein the door comprises a first door portion and a second door portion, the method comprising:
disengaging a latch securing the door to the door opening;
rotating, by actuating a first hinge coupling the first door portion to the door opening, the first door portion in a first direction;
rotating, simultaneously with the rotation of the first door portion, the second door portion at an angle to the first door portion such that a length of the door in an open position is less than a closed position, wherein the second door portion is coupled to the first door portion at a second hinge; and
lockingly engaging the door in the open position.

11. The method of claim 10, further comprising:
disengaging the door in the open position;
rotating, by actuating the first hinge, the first door portion a second direction opposite the first direction;
rotating, simultaneously with the rotation of the first door portion, the second door portion to form a single surface with the first door portion in the closed position; and
engaging the latch securing the door in the door opening.

12. The method of claim 10, wherein rotating the second door portion further comprises:
determining, by way of a sensor, a distance between the second door portion and a structure; and
beginning rotation of the second door portion when the distance between the second door portion and the structure is less than a threshold distance.

13. A vehicle comprising:
a body forming a door opening;
a first hinge coupled to the body;
a second hinge coupled to the body; and
a door coupled to the body at the door opening, wherein the door comprises:
a first door portion coupled to the first hinge and configured to rotate open in a first direction; and
a second door portion coupled to the second hinge and configured to rotate open in a second direction opposite the first direction,
wherein the first door portion is configured to securingly engage the second door portion.

14. The vehicle of claim 13, wherein the second door portion further comprises one or more steps.

15. The vehicle of claim 14, wherein the one or more steps are configured to rotate automatically during actuation of the second door portion between a first position and a second position, and wherein the one or more steps are flat against the second door portion in the first position and form an angle with the second door portion in the second position.

16. The vehicle of claim 13, wherein the door opening spans more than one row of seating disposed within the vehicle.

17. The vehicle of claim 13, wherein the second door portion further comprises a ramp.

18. The vehicle of claim 13, wherein the second door portion further comprises an armrest available to a user when the second door portion is engaged with the first door portion.

19. The vehicle of claim 13, wherein the first door portion and the second door portion are operably coupled to a controller, the controller causing rotation in the first door portion and the second door portion upon pressing of a button.

20. The vehicle of claim 13, wherein the first door portion and the second door portion comprise a single surface when the door opening is closed.
